(19) United States
(12) Patent Application Publication
(10) Pub. No.: US 2023/0084929 A1
(43) Pub. Date: Mar. 16, 2023

(54) COMMUNICATION DEVICE

(71) Applicant: KABUSHIKI KAISHA TOKAI RIKA DENKI SEISAKUSHO, Aichi (JP)

(72) Inventor: Masanori KOSUGI, Aichi (JP)

(73) Assignee: KABUSHIKI KAISHA TOKAI RIKA DENKI SEISAKUSHO, Aichi (JP)

(21) Appl. No.: 17/850,131

(22) Filed: Jun. 27, 2022

(30) Foreign Application Priority Data
Sep. 14, 2021 (JP) 2021-149404

(51) Int. Cl. H04W 64/00; G01S 1/08; H01Q 3/26

(52) U.S. Cl. CPC H04W 64/006; G01S 1/08; H01Q 3/2611

(57) ABSTRACT

There is provided a communication device that is to be disposed on an exterior of a mobile object, the communication device comprising a first antenna configured to transmit a signal for estimating a distance between the first antenna and other communication device in conformity with a first communication standard, wherein directivity of the signal transmitted by the first antenna is formed in such a manner that null related to the directivity is oriented to a height direction of the mobile object.

### CROSS REFERENCE TO RELATED APPLICATION(S)

This application is based upon and claims benefit of priority from Japanese Patent Application No. 2021-149404, filed on Sep. 14, 2021, the entire contents of which are incorporated herein by reference.

### BACKGROUND

The present invention relates to a communication device.

In recent years, technologies of performing a process based on wireless signals transmitted and received between devices have been developed. For example, JP 2020-118030A discloses a technology of estimating (ranging) a distance between devices by using ultra-wideband (UWB) signals.

### SUMMARY

A transmission signal such as a UWB signal has directivity. Thus, depending on the positional relationship between an antenna transmitting the UWB signal and a receiver, a situation may arise where the receiver has difficulty receiving the UWB signal transmitted from the antenna.

Accordingly, the present invention is made in view of the aforementioned difficulty, and an object of the present invention is to form directivity of a transmission signal that is more suitable for establishing communication.

To solve the above-described difficulty, according to an aspect of the present invention, there is provided a communication device that is to be disposed on an exterior of a mobile object, the communication device comprising a first antenna configured to transmit a signal for estimating a distance between the first antenna and other communication device in conformity with a first communication standard, wherein directivity of the signal transmitted by the first antenna is formed in such a manner that null related to the directivity is oriented to a height direction of the mobile object.

As described above, according to the present invention, it is possible to form directivity of a transmission signal that is more suitable for establishing communication.

### BRIEF DESCRIPTION OF THE DRAWINGS

FIG. 1 is a block diagram illustrating a configuration example of a wireless communication system 1 according to an embodiment of the present invention.

FIG. 2 is a diagram explaining ideal directivity of a typical dipole antenna.

FIG. 3 is a diagram illustrating an example of directivity of signals transmitted by a first antenna 110 according to an embodiment of the present invention.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

### 1.1. System Configuration Example

First, a configuration example of a wireless communication system 1 according to an embodiment of the present invention will be described.

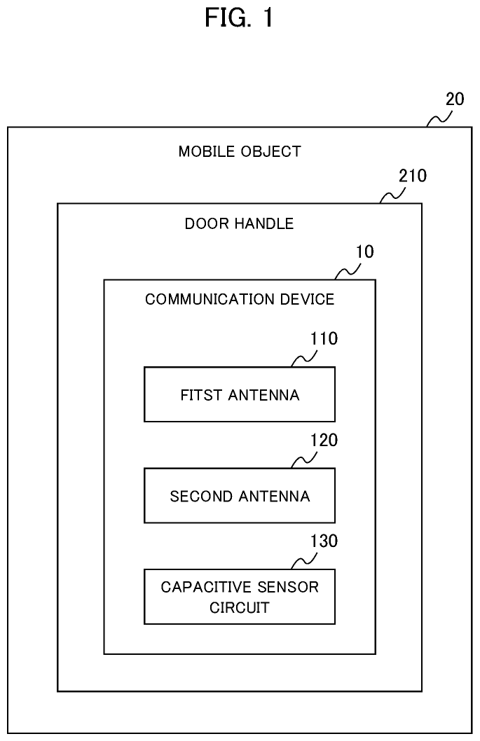

FIG. 1 is a block diagram illustrating the configuration example of the wireless communication system 1 according to the embodiment of the present invention.

The wireless communication system 1 according to the present embodiment includes a communication device 10 disposed on an exterior of a mobile object 20.

The mobile object 20 according to the present embodiment may be a vehicle, a ship, an airplane, or the like, for example.

FIG. 1 shows an example of a case in which the communication device 10 is embedded in a door handle 210 disposed on an exterior of the mobile object 20.

However, the configuration shown in FIG. 1 is a mere example. For example, the communication device 10 according to the present embodiment may be embedded in an exterior part such as pillar (B pillar, etc.) or door mirror.

(Communication Device 10)

The communication device 10 according to the present embodiment performs wireless communication with other communication device.

The other communication device may be a portable device carried by a user of the mobile object 20, for example. The user of the mobile object 20 includes, for example, an owner of the mobile object 20, a person authorized by the owner to use the mobile object 20, and the like.

As shown in FIG. 1, the communication device 10 according to the present embodiment includes a first antenna 110, a second antenna 120, and a capacitive sensor circuit 130.

(First Antenna 110)

The first antenna 110 according to the present embodiment transmits/receives signals used for estimating (ranging) a distance between the first antenna and the other communication device in conformity with a first communication standard.

The first communication standard according to the present embodiment may be UWB communication, for example.

(Second Antenna 120) The second antenna 120 according to the present embodiment transmits/receives signals used for authenticating the other communication device in conformity with a second communication standard.

For example, in the case of the second communication standard according to the present embodiment, low frequency (LF) band signals or ultra-high frequency (UHF) band signals may be used.

In this case, the second antenna 120 transmits the LF band signals.

(Capacitive Sensor Circuit 130)

The capacitive sensor circuit 130 according to the present embodiment detects proximity of an object on the basis of a change in capacitance.

The configuration example of the communication system 1 has been described above while focusing on the communication device 10 according to the embodiment of the present invention.

A control device (not illustrated) installed in the mobile object 20 may control, for example, unlocking of doors of the mobile object 20, on the basis of the wireless communication between the communication device 10 and the other communication device, proximity of an object detected by the communication device 10, and the like.

For example, the control device may permit the doors to be unlocked in the case where the distance between the communication device 10 and the other communication device estimated by ranging based on the signals complied with the first communication standard is a designated distance or less and authenticity of the other communication device is confirmed through authentication using signals complied with the second communication standard.

Otherwise, the control device may permit the doors to be unlocked in the case where the capacitive sensor circuit 130 detects that the door handle 210 is touched by the user, in addition to the above conditions.

Note that, the configuration of the communication device 10 described above with reference to FIG. 1 is a mere example. The configuration of the communication device 10 according to the present embodiment is not limited thereto.

For example, the communication device 10 according to the present embodiment may further include a third antenna that performs short-range wireless communication (such as near field communication (NFC)) with the other communication device.

In this case, the control device installed in the mobile object 20 may control, for example, unlocking of doors on the basis of a result of the short-range wireless communication between the communication device 10 and the other communication device, in addition to the above-described conditions or instead of some of the above-described conditions.

The configuration of the communication system 1 according to the present embodiment may be flexibly modified in accordance with specifications and operations.

### 1.2. Details

Next, features possessed by the communication device 10 according to the present embodiment and effects produced by the features will be explained in detail.

In general, it is known that signals transmitted from antennas do not spread uniformly in all directions but have directivities.

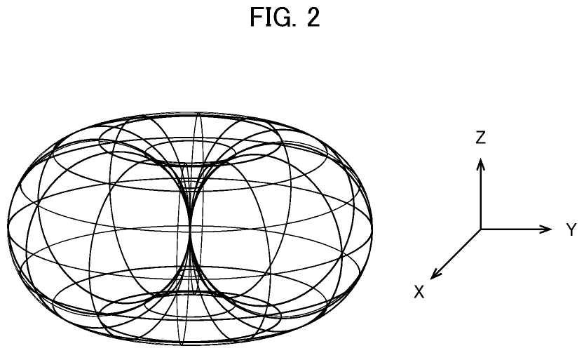

FIG. 2 is a diagram explaining ideal directivity of a typical dipole antenna.

FIG. 2 illustrates an image representing directivity of a transmission signal on three axes including X, Y, and Z axes centered on the typical dipole antenna.

In the case of the example shown in FIG. 2, the transmission signal has substantially uniform directivity on a two-dimensional plane formed by the X and Y axes, whereas the transmission signal has weaker directivity in the Z axis direction.

Thus, the directivity of the signal transmitted from an antenna has null (also called null zone or null field, etc.) where the signal transmission distance is extremely short (or almost no signal transmits) compared to other directions.

Therefore, in the case where the other communication device exists in the same direction as the null, a situation can occur where wireless communication between the communication device 10 and the other communication device may be difficult to establish.

The technical idea according to the embodiment of the present invention was conceived by focusing on the above-described points, and makes it possible to form directivity of a transmission signal that is more suitable for establishing communication.

For example, in the case where the mobile object 20 is a vehicle, users carrying the other communication device typically approach to the mobile object 20 from a horizontal direction, and it is assumed that few users approach to the mobile object 20 from a height direction (vertical direction) of the mobile object 20

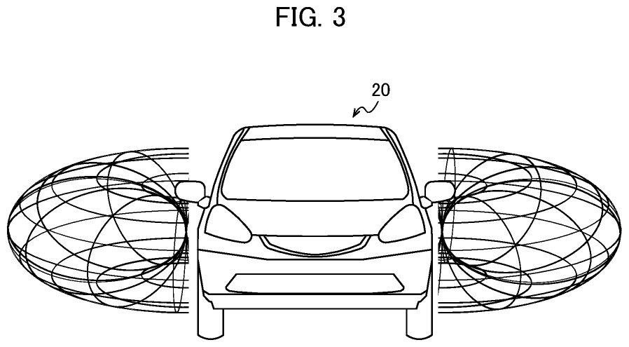

Therefore, the directivity of the signals transmitted by the first antenna 110 according to the present embodiment may be formed in such a manner that the null related to the directivity is oriented to a height direction of the mobile object 20 as shown in FIG. 3.

FIG. 3 is a diagram illustrating an example of the directivity of the signals transmitted by the first antenna 110 according to the embodiment.

Forming the directivity of the signals transmitted by the first antenna 110 as shown in FIG. 3, which makes it easier to establish the wireless communication between the communication device 10 installed in the mobile object 20 and the other communication device carried by the user approaching to the mobile object 20 from a horizontal direction. This makes it possible to control the mobile object 20 with high accuracy on the basis of the wireless communication.

The directivity of the signals transmitted by the first antenna 110 according to the present embodiment has been described in detail above. Note that, the directivity descried above may be obtained by the first antenna 110 alone or by a combination of the first antenna 110 and another structural element.

In addition, as mentioned above, the communication device 10 according to the present embodiment may be embedded in an exterior part such as the door handle 210 of the mobile object 20.

Signals such as the UWB signals used for ranging have a characteristic of being difficult to be diffracted. Thus, placing the communication device 10 on an exterior of the mobile object 20 makes it possible to eliminate influence of shielding materials such as glass and metal as much as possible and to expand the range of signal transmission.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

What is claimed is:

1. A communication device that is to be disposed on an exterior of a mobile object, the communication device comprising
a first antenna configured to transmit a signal for estimating a distance between the first antenna and other communication device in conformity with a first communication standard,
wherein directivity of the signal transmitted by the first antenna is formed in such a manner that null related to the directivity is oriented to a height direction of the mobile object.

2. The communication device according to claim 1,
wherein the communication device is configured to be embedded in a door handle disposed on the exterior of the mobile object.

3. The communication device according to claim 1, further comprising
a second antenna configured to transmit a signal for authenticating the other communication device in conformity with a second communication standard.

4. The communication device according to claim 1, further comprising
a capacitive sensor circuit configured to detect proximity of an object on a basis of a change in capacitance.

5. The communication device according to 1,
wherein the first communication standard includes ultra-wideband wireless communication.
